(19) United States
(12) Patent Application Publication
(10) Pub. No.: US 2012/0242146 A1
(43) Pub. Date: Sep. 27, 2012

(54) Power Management Device

(76) Inventor: Ting-Yu Chang, New Taipei City (TW)

(21) Appl. No.: 13/171,412

(22) Filed: Jun. 28, 2011

(30) Foreign Application Priority Data
Mar. 23, 2011 (TW) 100109856

(51) Int. Cl. H02J 1/00

(52) U.S. Cl. 307/29

(57) ABSTRACT

A power management device includes a plurality of power reception terminals for connecting a plurality of power adapters to receive power outputted by the plurality of power reception terminals, a plurality of power output terminals for connecting to a plurality of electronic devices, and a distribution module electrically connected to the plurality of power reception terminals and the plurality of power output terminals, for controlling power supplying between the plurality of power reception terminals and the plurality of power output terminals according to power providing statuses of the plurality of power adapters corresponding to the plurality of power reception terminals.

### BACKGROUND OF THE INVENTION

1. Field of the Invention

The present invention relates to a power management device, and more particularly, to a power management device capable of efficiently utilizing unused power in power adapters.

2. Description of the Prior Art

With advancement of electronic technologies, compact, low-power, and external power adapters for desktop computer systems are gradually replacing conventional power supplies that conform to the Advanced Technology Extended (ATX) power standard, to meet trends for smaller sizes and lower power costs. Generally, to ensure normal operations under various circumstances, a computer system is usually configured with a power adaptor having a power higher than needed. For example, if a computer system consumes a power of 40 watts under normal operations (e.g. document processing, web browsing, etc.), it maybe configured with a 90-watt power adapter, so as to cope with sudden high power requirements. In other words, under most circumstances, power utilization in a power supply for a computer system is lower than 50%. In such a case, efficient utilization of unused power in power adapters has become a major focus for the industry.

### SUMMARY OF THE INVENTION

Therefore, the present invention primarily provides a power management device.

The present invention discloses a power management device, including a plurality of power reception terminals, for connecting to a plurality of power adapters to receive power outputted by the plurality of power adapters, a plurality of power output terminals, for connecting to a plurality of electronic devices, and a distribution module, electrically connected to the plurality of power reception terminals and the plurality of power output terminals, for controlling power supplying between the plurality of power adapters and the plurality of power output terminals according to power providing statuses of the plurality of power adapters corresponding to the plurality of power reception terminals.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a power management device according to an embodiment of the present invention.

FIG. 2 is a schematic diagram of a distribution module according to an embodiment of the present invention.

FIG. 3 is a schematic diagram of a distribution module according to an embodiment of the present invention.

FIG. 4 is a schematic diagram of a distribution module according to an embodiment of the present invention.

FIG. 5A is a schematic diagram of a buffer circuit in the power management device shown in FIG. 1.

FIG. 5B is a schematic diagram of a power adjustment circuit in the power management device shown in FIG. 1.

### DETAILED DESCRIPTION

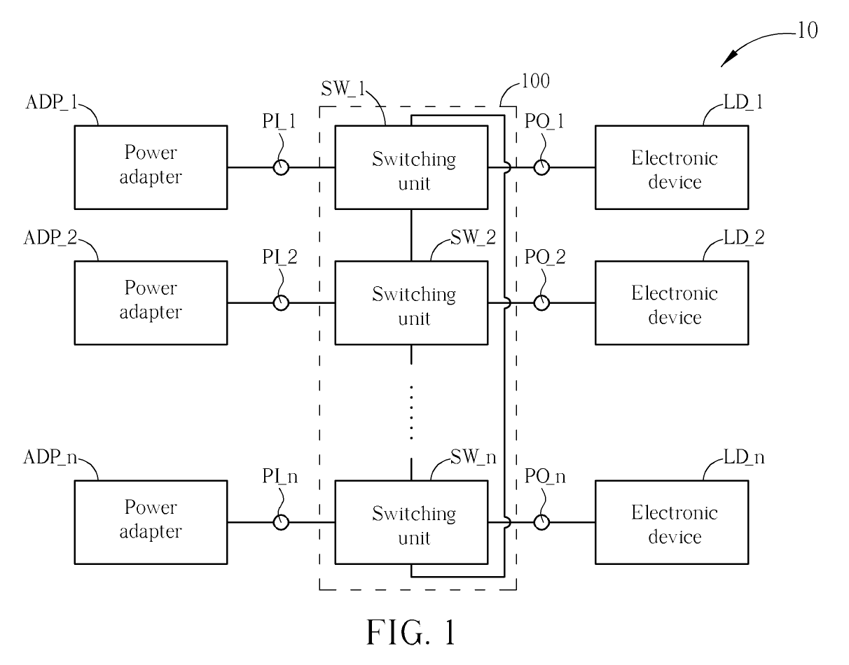

Please refer to FIG. 1, which is a schematic diagram of a power management device 10 according to an embodiment of the present invention. The power management device 10 is capable of effectively managing power outputted by power adapters ADP_1-ADP_n, to provide power for electronic devices LD_1-LD_n. The electronic devices LD_1-LD_n can be computer systems, stereo systems, household appliances or any other electronic devices, and the power adapters ADP_1-ADP_n can output direct current (DC) power suitable for the electronic devices LD_1-LD_n. The power management device 10 is formed by power reception terminals PI_1-PI_n, power output terminals PO_1-PO_n and a distribution module 100. The power reception terminals PI_1-PI_n and the power output terminals PO_1-PO_n are utilized for connecting to the power adapters ADP_1-ADP_n and the electronic devices LD_1-LD_n, respectively. The distribution module 100 is capable of controlling power supplying between the plurality of power reception terminals PI_1-PI_n and the plurality of power output terminals PO_1-PO_n according to power providing statuses of the plurality of power adapters ADP_1-ADP_n corresponding to the plurality of power reception terminals PI_1-PI_n.

In more detail, the distribution module 100 includes switching units SW_1-SW_n connected in a series. Each of the switching units SW_1-SW_n is electrically connected to a power reception terminal and a power output terminal, and used for controlling a conduction from the power reception terminal to the power output terminal according to a voltage of the corresponding power reception terminal. For example, the switching unit SW_1 controls a conduction between the power reception terminal PI_1 and the power output terminal PO_1 according to a voltage of the power reception terminal PI_1 (i.e. a power providing status of the power adapter ADP_1 corresponding to the power reception terminal PI_1). Furthermore, each of the switching units SW_1-SW_n can control its conduction toward an adjacent switching unit, according to a power receiving status of the adjacent switching unit. For example, the switching unit SW_1 can control its conduction toward the switching unit SW_2 or SW_n, according to voltage of the power reception terminal PI_2 or PI_n (i.e. the power supply receiving status of the switching unit SW_2 or SW_n).

In short, the distribution module 100 distributes power received by the power reception terminals PI_1-PI_n to the power output terminals PP_1-PO_n, to provide power for the electronic devices LD_1-LD_n. As such, when certain power adapters of the power adapters ADP_1-ADP_n are inactive, malfunctioning, or not correctly connected to the corresponding power reception terminals, the distribution module 100 may still distribute unused power from the other power adapters to all of the electronic devices. For example, suppose the power adapter ADP_1 of the power adapters ADP_1-ADP_n malfunctions, the distribution module 100 may distribute unused power from the power adapters ADP_2-ADP_n to the power output terminal PO_1, so as to ensure normal operation of the electronic device LD_1.

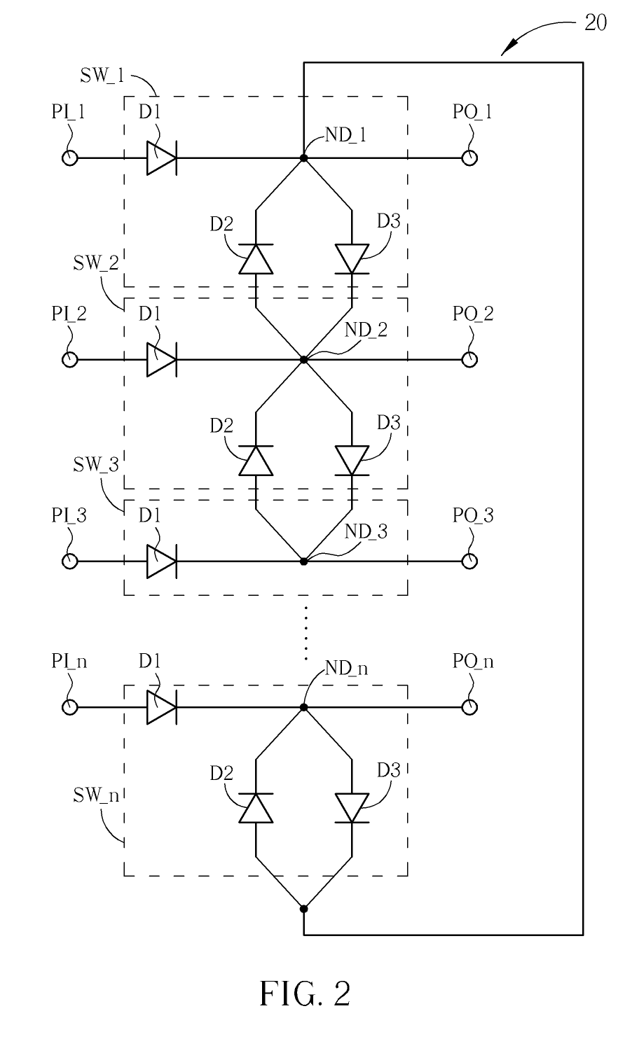

Various implementations for the above-mentioned concept are possible. For example, FIG. 2 is a schematic diagram of a distribution module 20 according to an embodiment of the present invention. The distribution module 20 implements the distribution module 100 in FIG. 1, and thus same denotations as the distribution module 100 are used. As shown in FIG. 2, switching units SW_1-SW_n in the distribution module 20 are formed by diodes D1, D2, and D3. Additionally, for illustrative purposes, intersections between the diodes D1, D2, and D3 of the switching units SW_1-SW_n and the power output terminals PO_1-PO_n are denoted as nodes ND_1-ND_n. As is well known by those skilled in the art, the diodes D1, D2, and D3 may be utilized as unidirectional switches, i.e. when a voltage difference between a P terminal and an N terminal is equal to or greater than a threshold value (e.g. 0.7V), a current path from the P terminal to the N terminal is conducted; conversely, when the voltage difference between the P terminal and the N terminal is smaller than the threshold value, the current path from the P terminal to the N terminal is cut off. In other words, with the switching unit SW_1 as an example, when a voltage difference between the power reception terminal PI_1 and the node ND_1 is greater than the threshold value, the diode D1 is turned on (conducted); when the voltage difference between the nodes ND_1 and ND_2 is greater than the threshold value, the diode D2 is turned off and the diode D3 is turned on; and when the voltage difference between the nodes ND_2 and ND_1 is greater than the threshold value, the diode D2 is turned on and the diode D3 is turned off. Operations of the other switching units SW_2-SW_n may be similarly derived. In such a case, assuming all of the power reception terminals PI_1-PI_n correctly receive power outputted by the power adapters ADP_1-ADP_n, and all have same or similar voltages, then all of the diodes D1 of the switching units SW_1-SW_n are turned on and all of the diodes D2, D3 are turned off. In other words, the power adapters ADP_1-ADP_n output power to the electronic devices LD_1-LD_n, respectively, and the distribution module 20 does not perform power distribution.

Conversely, assume a certain power reception terminal of the power reception terminals PI_1-PI_n does not receive power outputted by the corresponding power adapter, e.g. the power adapter malfunctions or is not correctly connected to the power reception terminal, then the distribution module 20 would perform power distribution. For example, if the power reception terminal PI_1 does not receive power outputted by the power adapter ADP_1, while all of the other power reception terminals PI_2-PI_n correctly receive power outputted by the corresponding power adapters, then the diodes D1, D3 of the switching unit SW_1 are turned off and the diode D2 is turned on, such that power received by the power reception terminal PI_2 is conducted to the power output terminal PO_1 via the node ND_2 and the diode D2 of the switching unit SW_1; concurrently, the diode D3 of the switching unit SW_n is turned on, such that power received by the power reception terminal PI_n is conducted to the power output terminal PO_1 via the diode D3 of the switching unit SW_n and node ND_1. In other words, the distribution module 20 is capable of distributing power outputted by the power adapters ADP_2-ADP_n to the power output terminals PO_1, so as to ensure normal operation of the electronic device LD_1.

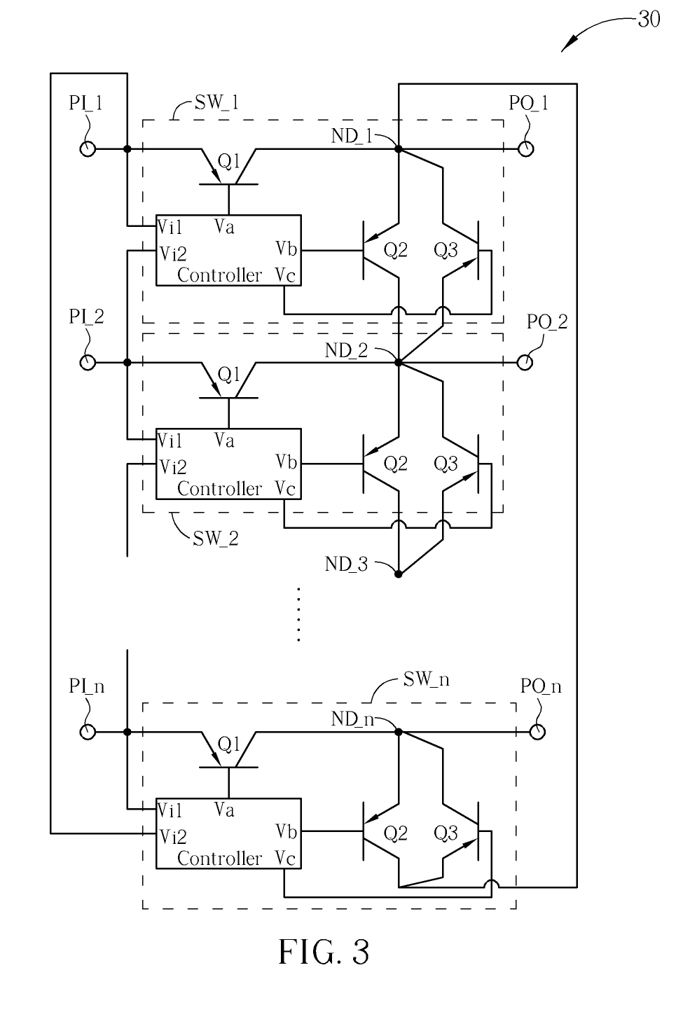

Apart from utilizing diodes, it is also possible to utilize bipolar junction transistors (BJTs) to implement the switching units SW_1-SW_n. Please refer to FIG. 3, which is a schematic diagram of a distribution module 30 according to an embodiment of the present invention. The distribution module 30 implements the distribution module 100 shown in FIG. 1, and thus same denotations as the distribution module 100 are used. As shown in FIG. 3, switching units SW_1-SW_n of the distribution module 30 are formed by transistors Q1, Q2, Q3, and a controller. Concurrently, for illustrative purposes, intersections between the transistors Q1, Q2, Q3 of the switching unit SW_1-SW_n and the power output terminals PO_1-PO_n are denoted nodes ND_1-ND_n. The transistors Q1, Q2, Q3 are P-type BJTs, having base terminals electrically connected to the controller. The controller outputs control voltages Va, Vb, Vc to control conductions from emitter terminals (power reception terminals) to collector terminals (power output terminals) of the transistors Q1, Q2, and Q3, according to power receiving statuses of the power reception terminals on a same stage (current stage) as the transistors Q1, Q2, Q3, as well as power receiving statuses of the power reception terminals on an adjacent stage (next stage), i.e. voltages Vi1 and Vi2 in FIG. 3. More specifically, the controller generates the control voltage Vc for the transistor Q3 according to the voltage Vi1 of the power reception terminal on the current stage, and generates the control voltages Va and Vb for the transistors Q1 and Q2, according to the voltage Vi2 of the power reception terminal on the next stage.

With the switching unit SW_1 as an example, during normal operations, a voltage of the power reception terminal PI_1 is greater than that of the base terminal of the transistor Q1. Thus, the transistor Q1 conducts, and power received at the power reception terminal PI_1 is conducted to the node ND_1, with the node ND_1 having a voltage similar to that of the power reception terminal PI_1. Consequently, the base terminal voltage of the transistor Q2 is higher than the emitter terminal voltage, such that the transistor Q2 is turned off, and power at the node ND_1 is not transferred to the node ND_2. Similarly, the base terminal voltage of the transistor Q3 is higher than the emitter terminal voltage, so the transistor Q3 is cut off, and power at the node ND_2 is not transferred to the node ND_1. Furthermore, the transistor Q2 of the switching unit SW_n is also turned off, due to a base terminal voltage higher than an emitter terminal voltage, such that power at the node ND_n is not transferred to the node ND_1. In short, during normal operations, there is a one-to-one relationship between the power reception terminals PI_1-PI_n and the power output terminals PO_1-PO_n.

Conversely, if the power reception terminal PI_1 does not receive power outputted by the power adapter ADP_1, while all of the other power reception terminals PI_2-PI_n receive power outputted by corresponding power adapters, the voltage at the power reception terminal PI_1 would be lower than the base terminal voltage of the transistor Q1 of the switching unit SW_1, and the transistor Q1 is turned off. Concurrently, since a voltage at the node ND_2 is higher than the base terminal voltage of the transistor Q3 of the switching unit SW_1, the transistor Q3 is turned on, and the power at the node ND_2 is transferred to the node ND_1. Furthermore, the transistor Q2 of the switching unit SW_n is also turned on due to having a higher voltage at the emitter terminal than at the base terminal voltage, and as a result, the power at the node ND_n is transferred to the node ND_1. It can be known that, if the power reception terminal PI_1 does not receive power outputted by the power adapter ADP_1 while all of the other power reception terminals PI_2-PI_n receive power outputted by the corresponding power adapters, the power at the power output terminal PO_1 (i.e. the node ND_1) would be supplied by other power output terminals.

As can be seen from the above, whether or not the transistors Q1, Q2, Q3 are conducted depends on power receiving statuses of power reception terminals of the same stage and power reception terminals of adjacent stages. In other words, when all of the power reception terminals PI_1-PI_n correctly receive power outputted by the power adapters ADP_1-ADP_n, and all have similar voltage levels, the transistors Q1 of the switching units SW_1-SW_n are turned on, and the transistors Q2, Q3 are cut off. In other words, the power adapters ADP_1-ADP_n output power to the electronic devices LD_1-LD_n, respectively. In this case, the distribution module 30 does not perform power distribution.

Conversely, assume a certain power reception terminal of the power reception terminals PI_1-PI_n does not receive power outputted by the corresponding power adapter, e.g. due to malfunction of the power adapter or because the power adapter is not correctly connected to the power reception terminal, then the distribution module 30 would perform power distribution. For example, if the power reception terminal PI_1 does not receive power outputted by the power adapter ADP_1, while all of the other power reception terminals PI_2-PI_n receive power from the corresponding power adapters, the transistors Q1, Q2 of the switching unit SW_1 would be turned off and the transistor Q3 would be turned on. Also, the transistor Q2 of the switching unit SW_n is turned on, such that power received by the power reception terminal PI2 is transferred to the node ND_1 via the switching unit SW_1, and power received by the power reception terminal PI_n is transferred to the node ND_1 via the transistor Q2 of the switching unit SW_n, to provide power to the power output terminal PO_1. Note that, the primary objective of the controllers of the switching units SW_1-SW_n is to ensure that when the power reception terminals correctly receive power, power can be transferred to corresponding power output terminals, and ensure that when adjacent power reception terminals do not correctly receive power, power supply can be directed to adjacent power output terminals.

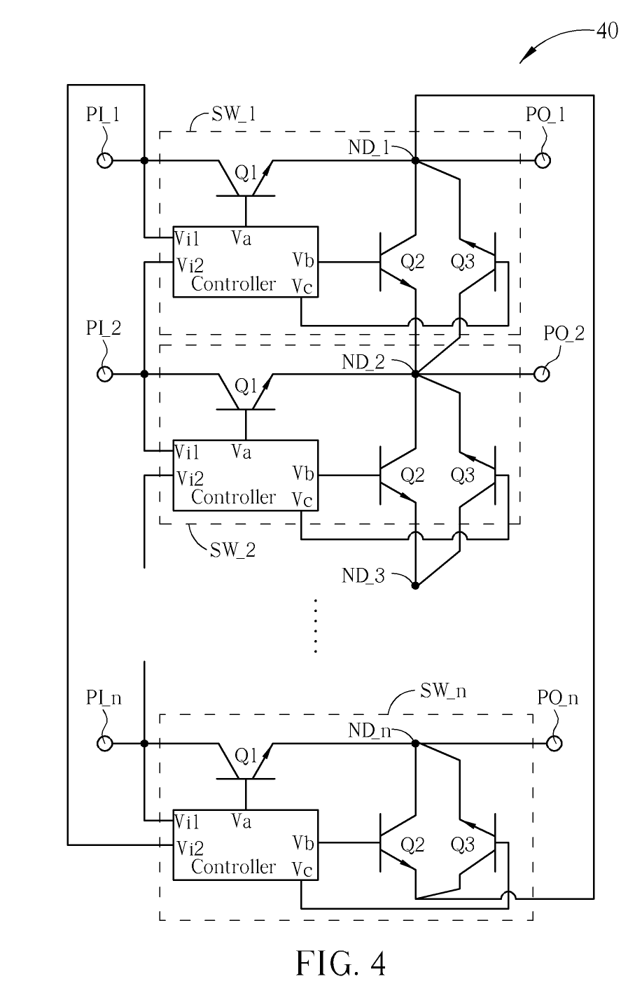

In FIG. 3, all of the transistors Q1, Q2, Q3 are P-type BJTs, which have superior current driving capabilities; however, when the electronic devices LD_1-LD_n do not impose strict current requirements, it is also possible to employ N-type BJTs. Please refer to FIG. 4, which is a schematic diagram of a distribution module 40 according to an embodiment of the present invention. The distribution module 40 is similar to the distribution module 30, apart from a distinction that the distribution module 40 employs N-type BJTs as the transistors Q1, Q2, Q3.

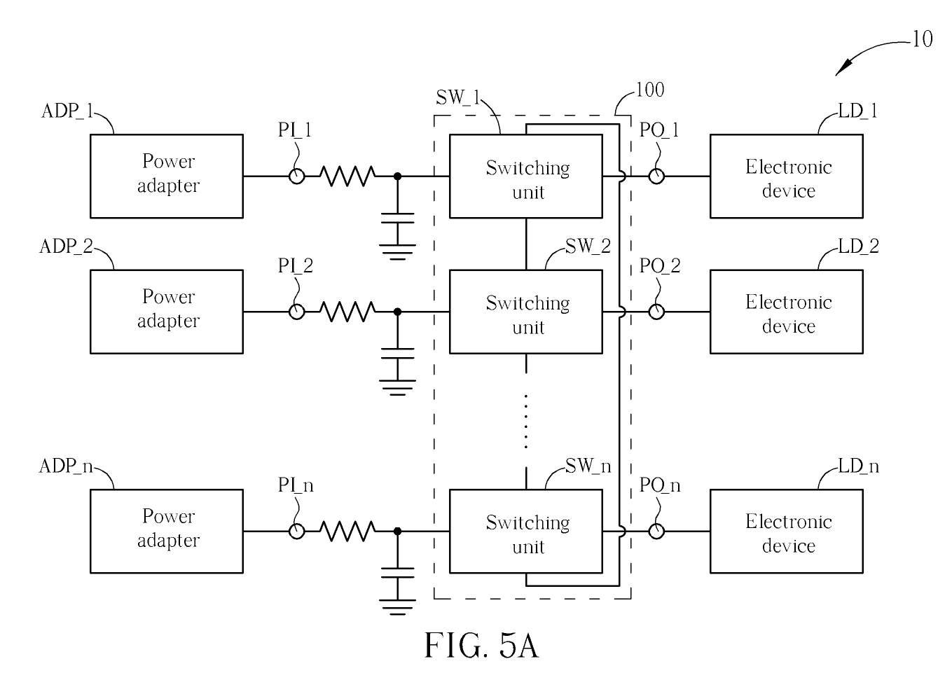

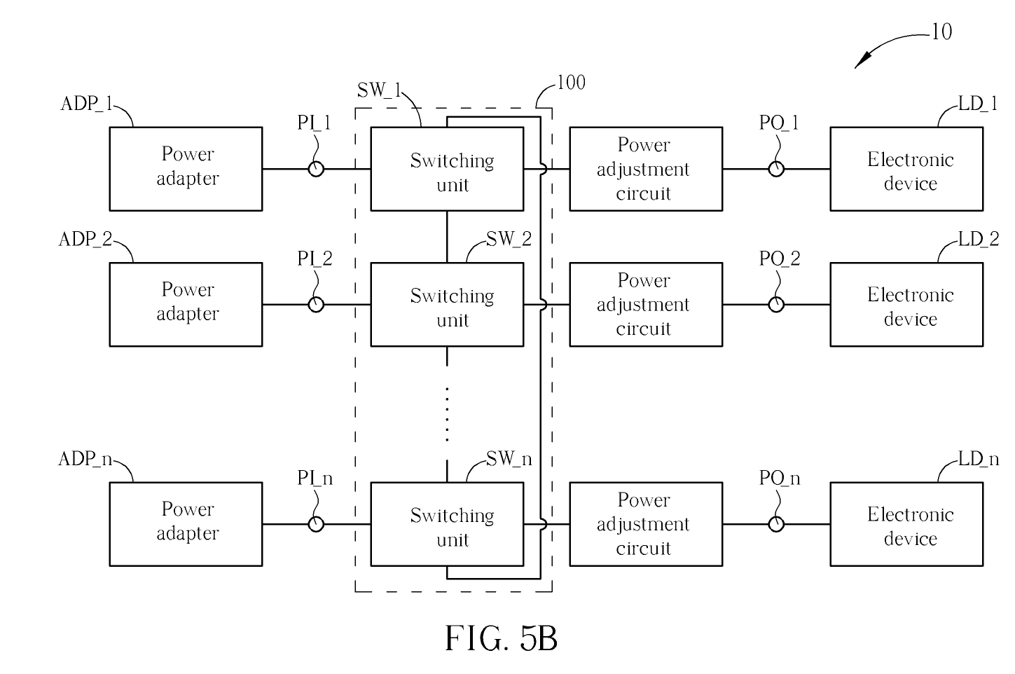

Moreover, please note that the essence of the present invention is to suitably distribute power supplied by the power adapters ADP_1-ADP_n, so as to direct unused power from normal power adapters to provide power for electronic devices corresponding to malfunctioning power adapters, when malfunction or incorrect connection occurs in one or more of the power adapters. Any variations made accordingly are within the scope of the present invention. For example, to prevent floating power reception terminals caused by malfunctioning power adapters or incorrect connections, it is possible to add a buffer circuit, formed by a capacitor and a resistor, between each of the power reception terminals PI_1-PI_n and the switching units SW_1-SW_n, as shown in FIG. 5A. Moreover, to ensure that power specifications outputted by the power output terminals PO_1-PO_n to the electronic devices LD_1-LD_n meet requirements, it is possible to add a power adjustment circuit between the power output terminals PO_1-PO_n and the switching units SW_1-SW_n, as shown in FIG. 5B, to ensure normal operations of the electronic devices LD_1-LD_n. The power adjustment circuit can be any form of direct current to direct current (DC-DC) convertor, e.g. pulse width modulator, pulse frequency modulator, etc.

In summary, the present invention is capable of suitably distributing power from the power adapters, when one or more of the power adapters malfunction or are not correctly connected, to direct unused power in power adapters to electronic devices corresponding to the malfunctioning power adapters, to efficiently utilize unused power in the power adapters, and achieve emergency backup power supply functionalities.

Those skilled in the art will readily observe that numerous modifications and alterations of the device and method may be made while retaining the teachings of the invention.

What is claimed is:

1. A power management device, comprising:
a plurality of power reception terminals, for connecting to a plurality of power adapters to receive power outputted by the plurality of power adapters;
a plurality of power output terminals, for connecting to a plurality of electronic devices; and
a distribution module, electrically connected to the plurality of power reception terminals and the plurality of power output terminals, for controlling power supplying between the plurality of power adapters and the plurality of power output terminals according to power providing statuses of the plurality of power adapters corresponding to the plurality of power reception terminals.

2. The power management device of claim 1, wherein when a first power adapter of the plurality of power adapters is not supplying power to the plurality of power reception terminals, and a second power adapter of the plurality of power adapters is supplying power to a power reception terminal of the plurality of power reception terminals, the distribution module directs the power supplied by the second power adapter to the plurality of power output terminals.

3. The power management device of claim 2, wherein the distribution module comprises a plurality of switching units, and each switching unit comprises:
a node, formed at a power output terminal of the plurality of power output terminals;
a first switch, electrically connected between a power reception terminal of the plurality of power reception terminals and the node, for conducting an electrical connection path from the power reception terminal to the node when a voltage of the power reception terminal is higher than a voltage of the node;
a second switch, electrically connected between the node and another power output terminal of the plurality of power output terminals, for conducting an electrical connection path from the another power output terminal to the node, when a voltage of the another power output terminal is higher than the voltage of the node; and
a third switch, electrically connected between the node and the another power output terminal, for conducting an electrical connection path from the node to the another power output terminal when the voltage of the node is higher than the voltage of the another power output terminal.

4. The power management device of claim 3, wherein the first switch is a diode, having a P terminal electrically connected to the power reception terminal and an N terminal electrically connected to the node; wherein the second switch is a diode, having an N terminal electrically connected to the another power output terminal and a P terminal electrically connected to the node; wherein the third switch is a diode, having an N terminal electrically connected to the node and a P terminal electrically connected to the another power output terminal.

5. The power management device of claim 3, wherein the each switching unit further comprises a power adjustment circuit, electrically connected between the node and the power output terminal, for converting a power specification of the node into a power specification required by an electronic device connected to the power output terminal.

6. The power management device of claim 2, wherein the distribution module comprises a plurality of switching units, and each switching unit comprises:
a node, formed at a power output terminal of the plurality of power output terminals;
a first switch, comprising a first terminal electrically connected to a power reception terminal of the plurality of power reception terminals, a second terminal electrically connected to the node, and a third terminal, for controlling a conduction status from the first terminal to the second terminal according to a signal received at the third terminal;
a second switch, comprising a first terminal electrically connected to the node, a second terminal electrically connected to another power output terminal of the plurality of power output terminals, and a third terminal, for controlling a conduction status from the first terminal to the second terminal according to a signal received at the third terminal;
a third switch, comprising a first terminal electrically connected to the another power output terminal, a second terminal electrically connected to the node, and a third terminal, for controlling a conduction status from the first terminal to the second terminal according to a signal received at the third terminal; and
a controller, electrically connected to the third terminal of the first switch, the third terminal of the second switch, the third terminal of the third switch, the power reception terminal and another power reception terminal of the plurality of power reception terminals, for outputting signals to the third terminal of the first switch, the third terminal of the second switch, and the third terminal of the third switch according to power received by the power reception terminal and the another power reception terminal, so as to control the first switch, the second switch, and the third switch.

7. The power management device of claim 6, wherein the first switch is a P-type bipolar junction transistor (BJT), the first terminal is an emitter terminal, the second terminal is a collector terminal, and the third terminal is a base terminal.

8. The power management device of claim 6, wherein the first switch is an N-type bipolar junction transistor (BJT), the first terminal is a collector terminal, the second terminal is an emitter terminal, and the third terminal is a base terminal.

9. The power management device of claim 6, wherein the second switch is a P-type bipolar junction transistor (BJT), the first terminal of the second switch is an emitter terminal, the second terminal is a collector terminal, and the third terminal is a base terminal; the third switch is a P-type BJT, the first terminal of the third switch is an emitter terminal, the second terminal is a collector terminal, and the third terminal is a base terminal.

10. The power management device of claim 6, wherein the second switch is an N-type bipolar junction transistor (BJT), the first terminal of the second switch is a collector terminal, the second terminal is an emitter terminal, and the third terminal is a base terminal; the third switch is an N-type BJT, the first terminal of the third switch is a collector terminal, the second terminal is an emitter terminal, and the third terminal is a base terminal.

11. The power management device of claim 6, wherein the each switching unit further comprises a power adjustment circuit, electrically connected between the node and the power output terminal, for converting a power specification of the node into a power specification required by an electronic device connected to the power output terminal.

12. The power management device of claim 1, wherein the plurality of electronic devices are a plurality of computer systems.
